(19) United States
(12) Patent Application Publication
(10) Pub. No.: US 2013/0152061 A1
(43) Pub. Date: Jun. 13, 2013

(54) FULL FIDELITY PARSE TREE FOR PROGRAMMING LANGUAGE PROCESSING

(71) Applicants: Peter Golde, Bellevue, WA (US); Matthew J. Warren, Redmond, WA (US); Neal M. Gafter, Bellevue, WA (US); HeeJae Chang, Issaquah, WA (US)

(72) Inventors: Peter Golde, Bellevue, WA (US); Matthew J. Warren, Redmond, WA (US); Neal M. Gafter, Bellevue, WA (US); HeeJae Chang, Issaquah, WA (US)

(73) Assignee: Microsoft Corporation, Redmond, WA (US)

(21) Appl. No.: 13/316,584

(22) Filed: Dec. 12, 2011

(51) Int. Cl. G06F 9/45

(52) U.S. Cl. 717/143

(57) ABSTRACT

An augmented parser can create an augmented parse tree that captures all the information in the source code as additional elements. Information included in the augmented parse tree can include whitespace, comments, pre-processor directives, line continuation characters, missing text, text errors, and original text. Thus, the augmented parse tree can be used to fully reconstruct the original source code, character for character, including spaces, comments, and incorrect code. The improved parser can store syntactic error information in the original source code in the parse tree. The augmented parse tree can be used to generate or modify source code. The parse tree created by the augmented parser can be used for incremental parsing to create a new augmented parse tree after a change.

### BACKGROUND

In computer science, a parse tree is an ordered, rooted tree that represents program constructs in the program source code. A parse tree is often built by a parser as part of the process of source code translation and compilation. In a traditional parse tree, interior nodes represent non-terminals of the grammar, and leaf nodes represent terminals of the grammar.

### SUMMARY

A parse tree as currently known in the art is inconvenient for modifying source code or for incrementally reparsing small changes in source code to produce a new parse tree. All of the information in the source code is not reflected in the parse tree. For example, spaces, tabs, comments, line continuation characters, incorrect text, and (in some languages) special directives are skipped by the parser. Syntactic errors found by the parser are typically either directly output or are stored in a separate error list. Thus, the traditional parse tree is not a full (complete) representation of the source text and cannot be used to reconstruct, character for character, the exact source text from which it was generated. A “full fidelity” parse tree, an augmented parse tree that captures all the information in the source code, can be created. The augmented parse tree data structure is convenient for modifying source code, creating new source code, and incrementally reparsing source code, and like a traditional parse tree, can still be used for code analysis and compilation.

An augmented parser can create an augmented parse tree that includes information concerning spaces, comments, and pre-processor directives as additional elements in the parse tree. Thus, the parse tree can be used to fully reconstruct the original program source code, character for character, including spaces, comments, and incorrect code. The augmented parser can store details of syntactic errors found in the original source code in the parse tree, instead of or in addition to, storing the details of the syntactic errors in a separate error list.

The augmented parse tree can provide a uniform data structure that can be used by tools for understanding programming language source code. The augmented parse tree can be used to generate or modify source code, including retaining comments and spaces that existed in the original source code. Tokens (words, numbers, punctuation and so on) that are skipped by a traditional parser (e.g., because of errors) can be accessed in the augmented parse tree. The augmented parse tree created by the augmented parser can be used for incremental parsing to create a new augmented parse tree after a change, without reprocessing the entire source file again. Non-syntactic information can be attached to tokens in the form of “trivia” nodes. Trivia nodes can include information such as spaces, tabs, and new lines (collectively referred to as “white space”), comments, line continuation punctuation in programming languages that use line continuation punctuation), tokens skipped by a traditional parser due to a syntax error, pre-processor directives, text that was skipped due to “pre-processing” and so on. Structured trivia nodes in the augmented parse tree can represent structured sub-parse trees including structured comments and structured directives. Trivia nodes in the augmented parse tree can represent “elastic space”, when creating new code. The augmented parse tree can be used to reconstruct the source code, character, for character, even in the presence of syntax errors. Syntax error information can be attached directly to nodes of the augmented parse tree, instead of or in addition to storing the syntax error information in a separate list of errors.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings:

FIG. 1a illustrates an example of a system 100 that creates an augmented parse tree in accordance with aspects of the subject matter disclosed herein;

FIG. 1b illustrates an example of an augmented parse tree 110 in accordance with aspects of the subject matter disclosed herein;

FIG. 2a illustrates an example of a method 200 that creates an augmented parse tree in accordance with aspects of the subject matter disclosed herein;

FIG. 2b illustrates an example of a method 230 that modifies an augmented parse tree in accordance with aspects of the subject matter disclosed herein;

FIG. 3 is a block diagram of an example of a computing environment in accordance with aspects of the subject matter disclosed herein; and

FIG. 4 is a block diagram of an example of an integrated development environment in accordance with aspects of the subject matter disclosed herein.

### DETAILED DESCRIPTION

### Overview

The traditional parse tree can be enhanced to include one or more additional nodes called trivia nodes. A trivia node can represent one of die following: a space, a tab, or a new line (collectively “white space”). A trivia node can represent elastic white space. A trivia node can represent a comment. A trivia node can represent line continuation punctuation. A trivia node can represent a token not otherwise processed by the parser because of the presence of a syntax error in the source code. A trivia node can represent a pre-processor directive. A trivia node can represent text that was not otherwise processed because of processing by a pre-processor. A node in the augmented parse tree can represent a token (e.g., a word, a number, a punctuation mark, etc.). A token can be associated with one or more lists. One of the lists can be a list of leading trivia. One of the lists can be a list of trailing trivia. The list or lists can include zero or more of the trivia items listed above that either precede or follow the particular token. If the augmented parser does not otherwise process a token because it fails to comply with the syntactic rules of the programming language, the token can be included in the augmented parse tree as a “skipped token” trivia node. Operations on the augmented parse tree that search for, return, or navigate between tokens may take these tokens into account.

If, in response to parsing the source code, the augmented parser determines that a token is missing, a node for a “missing” token for the missing element in the source code can be inserted into the augmented parse tree at the point at which the token would appear if the element were not missing in the source code. For example, consider the text:

{x=x+1}

This line of code is missing a required semicolon statement terminator between the “1” and the ending bracket. In response to receiving this statement, the augmented parser can create anode for the missing semicolon. A missing token node can include a property that identifies it as a missing token node and that distinguishes it from a token that is not missing.

Each node represented in the augmented parse tree can be converted into the exact text that was used to create it. That is, if a particular numeric value is received in a particular textual format, that particular textual format can be stored in the augmented parse tree. For example, information stored in the augmented parse tree for the token for a number can distinguish whether it was created from “5”, “5.0” or “5.00” in the source code as entered by the user. Each trivia node represented in the augmented parse tree can be converted into the exact text that was used to create it. Because the text in the source code, character for character is stored in the augmented parse tree, nodes in the augmented parse tree can be converted character for character back into the source code that was processed to create it.

When using the augmented parse tree for creating or modifying source code, nodes for elastic trivia make it possible to make edits with automatic formatting and not change pre-existing source code. The presence of elastic trivia nodes in the augmented parse tree can indicate to code formatting application programming interfaces (APIs) that additional spaces or lines can be added to source code in order to create source code with a user's intended formatting. Non-elastic whitespace is unchanged by the formatter. Elastic trivia nodes make it possible for a formatting engine to distinguish between source code to which formatting rules are to be applied and source code to which formatting rules are not be applied.

When the augmented parser diagnoses a syntax error, the error can be attached to a particular type of node in the augmented parse tree, instead of or in addition to being output or placed into an error list. The set of errors associated with a node or a sub-tree of the augmented parse tree can be obtained.

An augmented parse tree can be created by calling APIs instead of being created by the augmented parser. The augmented parse tree thusly created can be transformed into text, (e.g., source code that reconstructs the original source code, character for character).

### Full Fidelity Parse Tree for Programming Language Processing

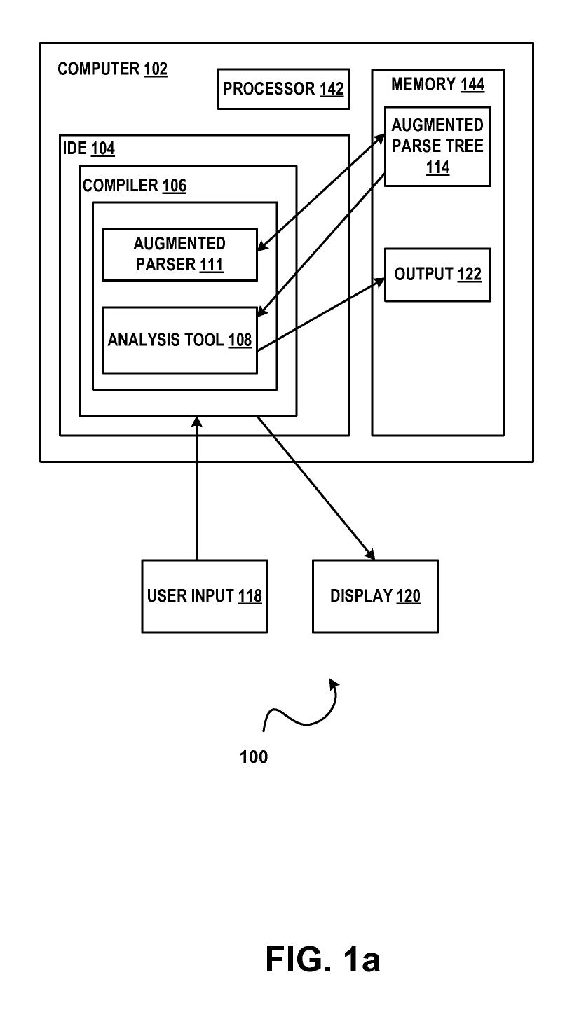

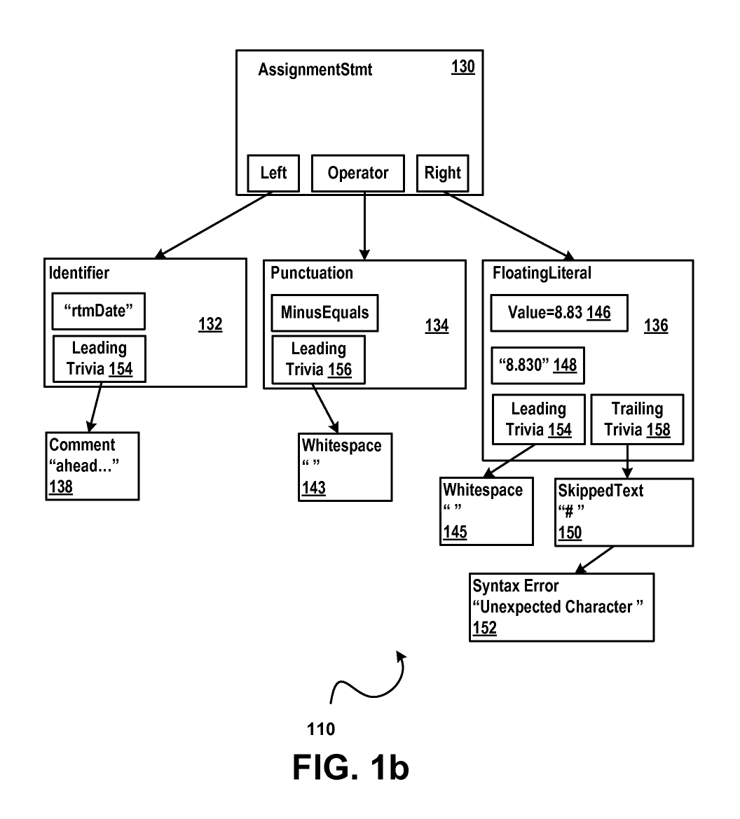

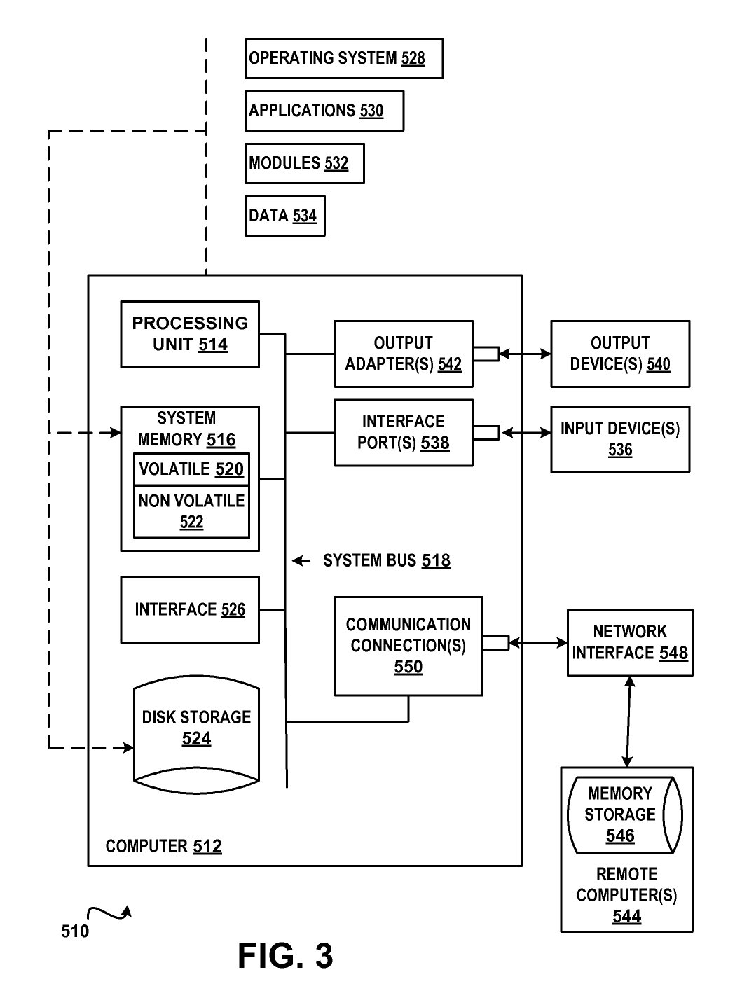

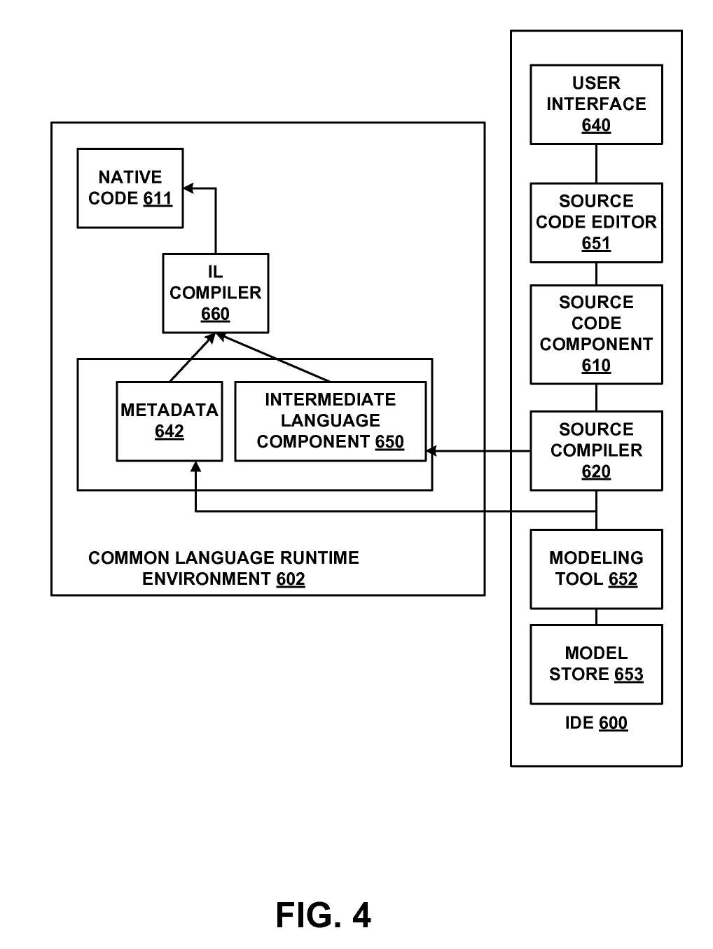

FIG. 1a illustrates an example of a system 100 that generates a full fidelity augmented parse tree in accordance with aspects of the subject matter disclosed herein. All or portions of system 100 may reside on one or more computers such as the computers described below with respect to FIG. 3. System 100 may execute on a software development computer such as the software development computer described with respect to FIG. 4. System 100 or portions thereof may execute within an integrated development environment or IDE such as IDE 104 or may execute outside of an IDE. The IDE can be an IDE such as the one described with respect to FIG. 4 or can be any other IDE. All or portions of system 100 may be implemented as a plug-in or add-on.

System 100 may include one or more computers or computing devices such as a computer 102 comprising: one or more processors such as processor 142, etc., a memory such as memory 144, and a compiler 106 comprising an augmented parser such as augmented parser 111. IDE 104 can include other code analysis tools, represented in FIG. 1a by analysis tools 108. The augmented parser can create and/or modify an augmented parse tree such as augmented parse tree 114 in memory 144. System 100 may also include other components (not shown) known in the arts. The augmented parser can receive user input such as user input 118. User input can comprise source code in any suitable programming language including but not limited to C#, Microsoft's Visual Basic®, XML and C++. The augmented parse tree can be input to various known and as yet unknown analysis tools 108 which may produce various output 122. The augmented parse tree 114 can be displayed in a display such as display 120.

An augmented parse tree such as augmented parse tree 114 can represent the lexical and syntactic structure of source code (e.g., user input 118). An augmented parse tree can enable program modules in an IDE, in add-ins, in code analysis tools, and in refactoring tools to access and process the syntactic structure of source code in a user software development project or other group of software development programs. The augmented parse tree 114 can enable program modules in an IDE, in add-ins, in code analysis tools, and in refactoring tools to create, modify, and rearrange source code without using direct text edits. By creating and manipulating the augmented parse tree 114, program modules can create and rearrange source.

An augmented parse tree can be comprised of various types of nodes. FIG. 1b illustrates an example of an augmented parse tree 110 representing source text:

‘ahead of schedule

rtmDate−=8.830#

In augmented parse tree 110, nodes 130, 132, 134 and 136 are syntax nodes. For example, node 130 represents an assignment statement:
rtmDate−=8.830#
An assignment statement typically includes something that is being assigned to (e.g., an identifier, represented by token node 132 “rtmDate”), an operator (e.g., punctuation−=“MinusEquals”) represented by token node 134 and an expression, (e.g., a floating literal with the value 8.83 146) represented by token node 136. Node 132 includes a leading trivia list 154 comprised of leading trivia node 138. Node 134 includes a leading trivia list 156 comprised of leading trivia node 143. Node 136 includes a leading trivia list 154 comprised of leading trivia node 145 and trailing trivia list 158 comprised of trailing trivia node 150.

Leading trivia node 138, leading trivia node 143, leading trivia node 145, and trailing trivia node 150 are trivia nodes, in accordance with aspects of the subject matter described herein. Node 152 is a diagnostic (error) attached to trailing trivia node 150. Leading trivia node 138 is a comment trivia node that represents a comment “ahead of schedule” associated with token node 132. Leading trivia node 143 is a whitespace trivia node associated with the punctuation MinusEquals syntax node 134 and represents the space preceding the operator−=, MinusEqual, in the statement:

rtmDate−=8.830#

Leading trivia node 145 is a whitespace trivia node associated with the floating literal token node 136. Node 136 represents the floating literal includes both a value (e.g., 8.83 146) and preserves the way the value exists in the source code input (e.g., “8.830” 148). Trailing trivia node 150 is a skipped text trivia node. The text “#” is skipped because the parser does not expect a “#” in the statement:

rtmDate−=8.830#

Node 152 is a data structure that represents a syntax error (e.g., an “unexpected character” was encountered).

One or more classes of nodes can exist, each node class representing a different kind of syntactic construct. Each node in the augmented parse tree can be an instance of one of the node classes. Nodes can be linked into an augmented parse tree. The augmented parse tree can be immutable. The augmented parse tree can be thread-safe.

An augmented parse tree obtained from the augmented parser can be completely round-trippable back to the text from which it was parsed. The text representation of the parse tree rooted at a selected node can be accessed, and a sequence of character including spaces, comments, and the exact representation of literals can be obtained. The augmented parse tree created by the augmented parser can produce text that matches exactly, character for character, the text that was parsed. The augmented parse tree can include all the information in the source text in a manner which is optimized for structural information.

The augmented parse tree can hold all the source text information in full fidelity. Source text can be created in full fidelity by creating an augmented parse tree and then converting the augmented parse tree into source code. Source text can be modified by creating a new augmented parse tree (not shown in FIG. 1a) that re-uses portions (e.g., one or more sub-trees) of the original augmented parse tree, and reconstructing the modified source code from the new augmented parse tree. Every node in the tree can represent a consecutive sequence of text. Child nodes of a particular node can represent smaller sub-sequences of that text, down to individual token nodes and whitespace nodes.

The nodes of the augmented parse tree can include different kinds of node classes including non-terminal nodes, token nodes, and trivia nodes. Non-terminal nodes are nodes that have non-terminal nodes or token nodes as their child nodes. In FIG. 1b node 130 is a non-terminal node. Nodes 132, 134 and 136 are token nodes. Nodes 138, 140, 145 and 150 are trivia nodes. Each non-terminal node can have a property (e.g., the property “Children”), which returns an indexed, read-only list of the node's child nodes or children, in sequential (source code) order.

The nodes of the augmented parse tree can include token nodes. In accordance with aspects of the subject matter disclosed herein, tokens can be the terminals of the syntactic grammar, and can include keywords, identifiers, literals, and punctuation. Because the augmented parse tree enables exact round-tripping to text, tokens may need to store more data than might be initially expected. For example, to enable exact reproduction of the original source text, a VisualBasic® keyword such as “ForEach” has to be distinguishable from “FOREACH”, the floating point literal “1000” has to be distinguishable from “1E3”, and the C# string literals “hello” has to be distinguishable from “h\u0065llo”. The augmented parser can use the same object instance for identical token nodes and/or identical pieces of string data, such as identical identifiers to increase memory efficiency.

The nodes of the augmented parse tree can include trivia nodes. Because the augmented parse tree is intended to capture all of the lexical and syntactic information about a source file, and be round-trippable, the augmented parse tree can include node classes that represent items that are not syntactically significant. These types of node classes can be designated as a trivia node class. A trivia node class can include content in the source code comprising whitespace including tabs, spaces, and line terminators, comments, pre-processor directives (e.g., any line beginning with #), skipped text, (e.g., text that was skipped as a result of processing an #if directive) and so on.

Trivia nodes in accordance with some aspects of the subject matter described herein are directly associated with tokens. A method on a token (e.g., called GetPrecedingTrivia( )) can return a read-only, indexed list of nodes that represent the trivia before the token. A method that is called on a token node that gets trivia following the token (e.g., called GetFollowingTrivia( )) can return a read-only, indexed list of nodes that represent the trivia after the token. These methods can be recursively defined for non-terminal nodes. For a non-terminal node, a method that gets trivia that precedes a non-terminal (e.g., GetPrecedingTrivia( )) can return the same content as calling the method on the first child of the node representing the non-terminal. Similarly, a method called on a non-terminal node that gets trivia that follows the non-terminal in the source code (e.g., GetFollowingTrivia( )) can return the same content as calling the method on the last child of the node representing the non-terminal in the source code. This feature can be used to obtained comments logically associated with a statement, class, or declaration. Compilers and other program modules that address language syntax can ignore the trivia nodes, as they never appear in the Children list or in the named child properties: trivia nodes are only returned from the methods that get preceding trivia( ) and get following trivia.

In accordance with aspects of the subject matter disclosed herein, a tree structure can be created for a trivia node for source code that has structured content. For example, XML documentation comments have a tree-like structure of XML nodes and text within the XML. A structured trivia node can be used to store the structured XML documentation comments. A method (e.g., GetStructure( )) can be called on a structured trivia node, the method returning a non-terminal node that is the root of the structured content within the trivia node. The sub-tree of the augmented parse tree that stores structured trivia content can include non-terminal nodes, token nodes, and trivia nodes.

A program source code development environment can include an automatic formatting feature. As a user types or after the user has made one of a series of edits, the source code editor can reformat the just written text to abide by a preset set of rules for spacing and line breaks. The formatting rules can be adaptable and can adjust to a programmer's overrides as the programmer makes changes to a local region. Historically, when a code transformation or synthesis generates code, the code is automatically formatted according to the user's preferences. If a code transformation is made to a surrounding structure such as a block of program block, the formatting engine reformats the entire structure including the interior using a set of preset rules. Any explicit override made by a user (e.g., programmer) is lost. Elastic trivia nodes make it possible for the formatting engine to distinguish code that is to be formatted from pre-existing source code that is not to be reformatted. In accordance with aspects of the subject matter disclosed herein, the formatting engine can replace elastic trivia nodes with the correct amount of non-elastic whitespace, while leaving all non-elastic whitespace alone. When parsing existing code, the augmented parser does not create elastic trivia nodes. When new nodes are created during a code transformation or synthesis, the creator of those nodes can optionally create elastic trivia nodes before or after them, thereby allowing automatic formatting to reformat the code according to the preset formatted rules, including the user preferences.

An augmented parse tree can store information concerning syntax errors, so that incremental updates to the augmented parse tree can be performed. In particular, the augmented parse tree can be made as close to correct trees as possible, while making the location of syntax errors detectable.

The augmented parser can preserve information to enable program modules in the IDE and other tools to analyze the augmented parse tree, including partially formed constructs. Errors can be represented in a per-node error marker and list. Each node can have a property and a method on it, which allow error information associated with the sub-tree at and below that node to be accessed. A property can indicate whether or not the node has errors (e.g., a HasErrors property). This property of a node can return true if the node, or any of its child nodes, grand-child nodes, etc., have associated syntax errors. The error-indicating property can sum up error information throughout the sub-tree of nodes associated with the node, the statement or expression level can be examined.

A method called on the error property such as a GetErrorMessages( ) method can return an immutable collection of error messages within this node and all the child nodes, grandchild nodes, etc. and trivia nodes. Accessing the collection of error messages can be performed by traversing all parts of the augmented parse tree with errors.

A token node can have another property (e.g., IsMissing) which if true can denote that the token was actually not present in the parse tree, hut was synthesized by the augmented parser. The augmented parser can synthesize an IsMissing token node when the augmented parses expects a particular token of that type, but failed to find text matching the expected token type. A missing token node can be used when the augmented parser begins parsing a construct, and can decide or make a reasonable inference as to what kind of node to produce. If the augmented parser cannot fully complete parsing the construct that makes up the node, it can create a missing token node for all of the subsequent non-optional tokens, and place the subsequent non-optional tokens into the node. A missing node can be represented by having no underlying characters.

When recovering from syntax errors, the augmented parser may skip some of the text of the program before beginning parsing again. For example, the augmented parser can skip all text in the current statement, and start parsing again at the next statement or at a particular keyword. Because the augmented parse trees need to fully represent the source text, the skipped tokens can be represented as a particular kind of trivia node such as a SkippedTokensTrivia node. A SkippedTokensTrivia node can include the tokens that were skipped. Token navigation methods such as previous/next token can optionally take skipped tokens into account.

To enable refactoring and modification of code, new augmented parse tree nodes and new augmented parse trees can be created. Thus, in accordance with aspects of the subject matter disclosed herein, a node class can expose constructors that allow the creation of new nodes. Trivia nodes can have a common single constructor, typically with a node kind and text. For example:

new Comment(NodeKind.MultiLine, “hello”)
can create a new comment node. If converted to text, the text can appear as “/*hello*/”. Token nodes can have two forms of constructors. One type of constructor can take the token kind (if needed) and any data associated with the token, for example, as follows:
new Identifier(“hello”)

### new Punctuation(NodeKind.LeftParenthesis)

A second form of the constructor for tokens can allow additionally specifying leading and trailing trivia, as well as the IsMissing data.

Non-terminal nodes can have two constructors. The first kind of constructor can allow specification of all the child nodes. For example, a namespace node with name name and contents contents can be created by specifying:

new NameSpace(new Keyword(NodeKind.NameSpace),

name,

new Punctuation (NodeKind.LeftBrace),

contents,

new Punctuation (NodeKind.RightBrace));

This allows the full flexibility of specifying each child including attached trivia, (not shown in the above example). A second, simplified constructor can automatically insert “forced” tokens, so that a namespace could be more simply created by just specifying:

new NameSpace(name, contents);

In this case, the required keyword and punctuation can be automatically inserted, along with a space after the keyword “namespace”. Elastic whitespace can be inserted so that the declaration can be appropriately formatted according to the user's wishes.

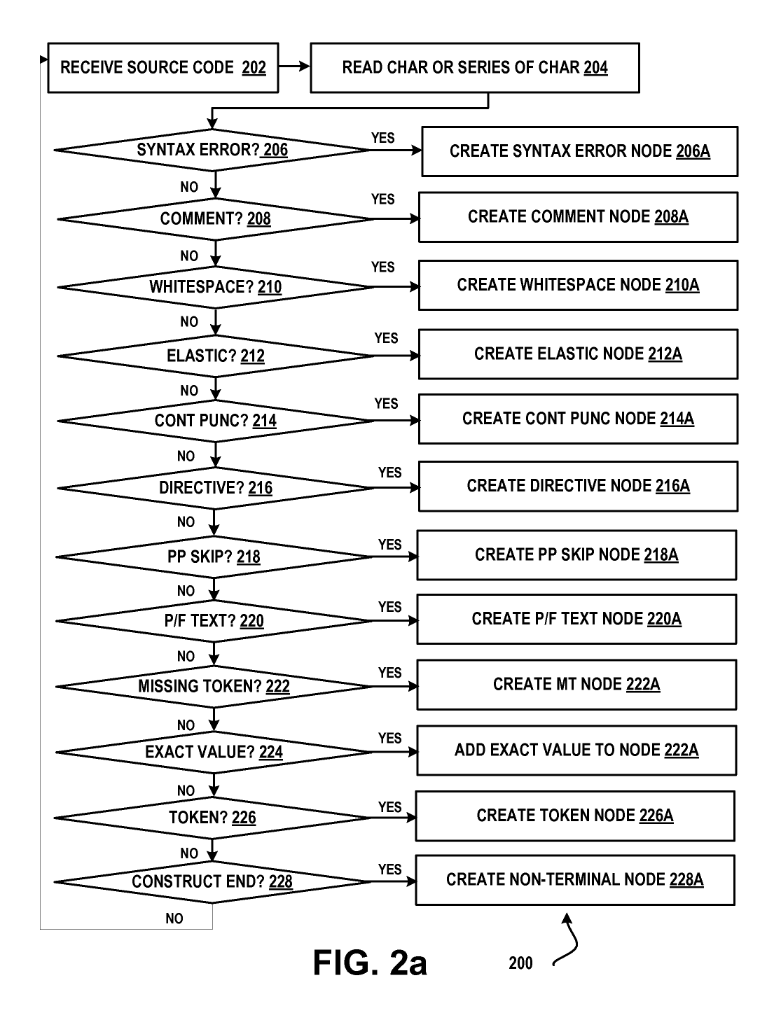

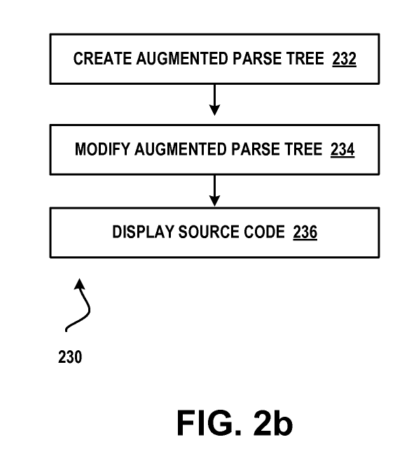

FIG. 2a illustrates a method 200 that can generate augmented parse trees in accordance with aspects of the subject matter disclosed herein. The method described in FIG. 2a can be practiced by a system such as but not limited to the one described with respect to FIG. 1a. While method 200 describes a series of acts that are performed in a sequence, it is to be understood that method 200 is not limited by the order of the sequence. For instance, some acts may occur in a different order than that described. In addition, an act may occur concurrently with another act. In some instances, not all acts may be performed.

At 202 user input comprising a character or series of characters of source code can be parsed by an augmented parser to create a portion of an augmented parse tree. The user input can comprise a pre-existing source code file. The input can comprise a source code file that is being written. The user input can comprise edits or modifications to an existing source code file. At 204 a character of the input can be received by the augmented parser. The character or a series of characters can be evaluated (e.g., for what type of information the character or characters represent). At 206, if the character or group of characters comprises a syntax error, a trivia node for the syntax error can be created at 206A and the syntax error can be stored at the created node. The created node can be associated with the token node to which it applies. At 208 if the character or series of characters is not a syntax error, the character or a series of characters can be evaluated. Hate character or group of characters comprises a comment, a trivia node for the comment can be created at 208A and the comment can be stored at the created node. The created node can be associated with the token node to which it applies. At 210 if the character or series of characters is not a comment, the character or a series of characters can be evaluated. If the character or group of characters comprises whitespace, a trivia node for the whitespace can be created at 210A and the whitespace can be stored at the created node. The created node can be associated with the token node to which it applies.

At 212 if the character or series of characters is not whitespace, the character or a series of characters can be evaluated. If the character or group of characters comprises elastic whitespace, a trivia node for the elastic whitespace can be created at 212A and the elastic whitespace indicator can be stored at the created node. The created node can be associated with the token node to which it applies. At 214 if the character or series of characters is not elastic whitespace, the character or a series of characters can be evaluated. If the character or group of characters comprises continuation punctuation, a trivia node for the continuation punctuation can be created at 214A and the continuation punctuation can be stored at the created node. The created node can be associated with the token node to which it applies. At 216 if the character or series of characters is not continuation punctuation, the character or a series of characters can be evaluated. If the character or group of characters comprises a pre-processor directive, a trivia node for the pre-processor directive can be created at 216A and the pre-processor directive can be stored at the created node. The created node can be associated with the token node to which it applies.

At 218 if the character or series of characters is not a pre-processor directive, the character or a series of characters can be evaluated. If the character or group of characters comprises text that was skipped because of pre-processing, a trivia node for the text skipped because of pre-processing can be created at 218A and the text skipped because of pre-processing can be stored at the created node. The created node can be associated with the token node to which it applies. At 220 if the character or series of characters is not text skipped because of pre-processing, the character or a series of characters can be evaluated. If the character or group of characters comprises text that was skipped, the text preceding or following a token node, respectively, a leading trivia node for the text skipped or a following or trailing trivia node for the text skipped can be created at 220A and associated with the token node. The created node can be associated with the token node to which it applies.

At 222 if the character or series of characters is not text skipped associated with a token, the character or a series of characters can be evaluated. If the augmented parser detects a missing token, a node for the missing token can be created at 222A. The created node can be associated with the token node to which it applies. At 224 if the character or series of characters is not a missing token, the character or a series of characters can be evaluated. If the character or group of characters comprises an exact value, the exact value can be stored with the token node at 224A. The created node can be associated with the token node to which it applies. At 226 if the character or series of characters is a token a token node can be created at 226A. At 228, if the end of a construct is detected, a non-terminal node can be created at 228A. The created node can be associated with the token node to which it applies. The non-terminal node can have child nodes. The process can be repeated any number of times.

FIG. 2b illustrates a method 230 that can modify an augmented parse tree in accordance with aspects of the subject matter disclosed herein. The method described in FIG. 2b can be practiced by a system such as hut not limited to the one described with respect to FIG. 1a. While method 230 describes a series of acts that are performed in a sequence, it is to be understood that method 230 is not limited by the order of the sequence. For instance, some acts may occur in a different order than that described. In addition, an act may occur concurrently with another act. In some instances, not all acts may be performed. At 232 an augmented parse tree can be created. At 234 the augmented parse tree can be modified. The augmented parse tree can be modified by creating a new parse tree that re-uses portions (e.g., one or more sub-trees) of the original augmented parse tree. At 236 the new augmented parse tree can be used to reconstruct the source code as modified, character for character, as described more fully above.

### Example of a Suitable Computing Environment

In order to provide context for various aspects of the subject matter disclosed herein, FIG. 3 and the following discussion are intended to provide a brief general description of a suitable computing environment 510 in which various embodiments of the subject matter disclosed herein may be implemented. While the subject matter disclosed herein is described in the general context of computer-executable instructions, such as program modules, executed by one or more computers or other computing devices, those skilled in the art will recognize that portions of the subject matter disclosed herein can also be implemented in combination with other program modules and/or a combination of hardware and software. Generally, program modules include routines, programs, objects, physical artifacts, data structures, etc. that perform particular tasks or implement particular data types. Typically, the functionality of the program modules may be combined or distributed as desired in various embodiments. The computing environment 510 is only one example of a suitable operating environment and is not intended to limit the scope of use or functionality of the subject matter disclosed herein.

With reference to FIG. 3, a computing device in the form of a computer 512 is described. Computer 512 may include at least one processing unit 514, a system memory 516, and a system bus 518. The at least one processing unit 514 can execute instructions that are stored in a memory such as but not limited to system memory 516. The processing unit 514 can be any of various available processors. For example, the processing unit 514 can be a CPU. The instructions can be instructions for implementing functionality carried out by one or more components or modules discussed above or instructions for implementing one or more of the methods described above. Dual microprocessors and other multiprocessor architectures also can be employed as the processing unit 514. The computer 512 may be used in a system that supports rendering graphics on a display screen. In another example, at least a portion of the computing device can be used in a system that comprises a graphical processing unit. The system memory 516 may include volatile memory 520 and nonvolatile memory 522. Nonvolatile memory 522 can include read only memory (ROM), programmable ROM (PROM), electrically programmable ROM (EPROM) or flash memory. Volatile memory 520 may include random access memory (RAM) which may act as external cache memory. The system bus 518 couples system physical artifacts including the system memory 516 to the processing unit 514. The system bus 518 can be any of several types including a memory bus, memory controller, peripheral bus, external bus, or local bus and may use any variety of available bus architectures. Computer 512 may include a data store accessible by the processing unit 514 by way of the system bus 518. The data store may include executable instructions, 3D models, materials, textures and so on for graphics rendering.

Computer 512 typically includes a variety of computer readable media such as volatile and nonvolatile media, removable and non-removable media. Computer storage media may be implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other transitory or non-transitory medium which can be used to store the desired information and which can be accessed by computer 512.

It will be appreciated that FIG. 3 describes software that can act as an intermediary between users and computer resources. This software may include an operating system 528 which can be stored on disk storage 524, and which can allocate resources of the computer 512. Disk storage 524 may be a hard disk drive connected to the system bus 518 through a non-removable memory interface such as interface 526. System applications 530 take advantage of the management of resources by operating system 528 through program modules 532 and program data 534 stored either in system memory 516 or on disk storage 524. It will be appreciated that computers can be implemented with various operating systems or combinations of operating systems.

A user can enter commands or information into the computer 512 through an input device(s) 536. Input devices 536 include but are not limited to a pointing device such as a mouse, trackball, stylus, touch pad, keyboard, microphone, and the like. These and other input devices connect to the processing unit 514 through the system bus 518 via interface port(s) 538. An interface port(s) 538 may represent a serial port, parallel port, universal serial bus (USB) and the like. Output devices(s) 540 may use the same type of ports as do the input devices. Output adapter 542 is provided to illustrate that there are some output devices 540 like monitors, speakers and printers that require particular adapters. Output adapters 542 include but are not limited to video and sound cards that provide a connection between the output device 540 and the system bus 518. Other devices and/or systems or devices such as remote computer(s) 544 may provide both input and output capabilities.

Computer 512 can operate in a networked environment using logical connections to one or more remote computers, such as a remote computer(s) 544. The remote computer 544 can be a personal computer, a server, a router, a network PC, a peer device or other common network node, and typically includes many or all of the elements described above relative to the computer 512, although only a memory storage device 546 has been illustrated in FIG. 3. Remote computer(s) 544 can be logically connected via communication connection(s) 550. Network interface 548 encompasses communication networks such as local area networks (LANs) and wide area networks (WANs) but may also include other networks. Communication connection(s) 550 refers to the hardware/software employed to connect the network interface 548 to the bus 518. Communication connection(s) 550 may be internal to or external to computer 512 and include internal and external technologies such as modems (telephone, cable, DSL and wireless) and ISDN adapters, Ethernet cards and so on.

It will be appreciated that the network connections shown are examples only and other means of establishing a communications link between the computers may be used. One of ordinary skill in the art can appreciate that a computer 512 or other client device can be deployed as part of a computer network. In this regard, the subject matter disclosed herein may pertain to any computer system having any number of memory or storage units, and any number of applications and processes occurring across any number of storage units or volumes. Aspects of the subject matter disclosed herein may apply to an environment with server computers and client computers deployed in a network environment, having remote or local storage. Aspects of the subject matter disclosed herein may also apply to a standalone computing device, having programming language functionality, interpretation and execution capabilities.

FIG. 4 illustrates an integrated development environment (IDE) 600 and Common Language Runtime Environment 602. An IDE 600 may allow a user (e.g., developer, programmer, designer, coder, etc.) to design, code, compile, test, run, edit, debug or build a program, set of programs, web sites, web applications, and web services in a computer system. Software programs can include source code (component 610), created in one or more source code languages e.g., Visual Basic, Visual J#, C++, C#, J#, Java Script, APL, COBOL, Pascal, Eiffel, Haskell; ML, Oberon, Perl, Python, Scheme, Smalltalk and the like). The IDE 600 may provide a native code development environment or may provide a managed code development that runs on a virtual machine or may provide a combination thereof. The IDE 600 may provide a managed code development environment using the .NET framework. An intermediate language component 650 may be created from the source code component 610 and the native code component 611 using a language specific source compiler 620 and the native code component 611 (e.g., machine executable instructions) is created from the intermediate language component 650 using the intermediate language compiler 660 (e.g. just-in-dine (JIT) compiler), when the application is executed. That is, when an IL application is executed, it is compiled while being executed into the appropriate machine language for the platform it is being executed on, thereby making code portable across several platforms. Alternatively, in other embodiments, programs may be compiled to native code machine language (not shown) appropriate for its intended platform.

A user can create and/or edit the source code component according to known software programming techniques and the specific logical and syntactical rules associated with a particular source language via a user interface 640 and a source code editor 651 in the IDE 600. Thereafter, the source code component 610 can be compiled via a source compiler 620, whereby an intermediate language representation of the program may be created, such as assembly 630. The assembly 630 may comprise the intermediate language component 650 and metadata 642. Application designs may be able to be validated before deployment.

The various techniques described herein may be implemented in connection with hardware or software or, where appropriate, with a combination of both. Thus, the methods and apparatus described herein, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing aspects of the subject matter disclosed herein. As used herein, the term “machine-readable medium” shall be taken to exclude any mechanism that provides (i.e., stores and/or transmits) any form of propagated signals. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects, e.g., through the use of a data processing API or the like, may be implemented in a high level procedural or object oriented programming language to communicate with a computer system. However, the program(s) can be implemented in assembly or machine language, if desired. In any case, the language may be a compiled or interpreted language, and combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system comprising:
at least one processor of a computing device;
a memory of the computing device; and
at least one module comprising an augmented parser loaded into the memory causing the at least one processor to:
receive at least one character of program source code, the at east one character comprising non-syntactic information;
determine a type of the at least one character;
create a new node in an augmented parse tree, the new node of the determined type of the at least one character; and
reconstruct the program source code character for character from the augmented parse tree.

2. The system of claim 1, further comprising:
receiving non-syntactic information comprising whitespace;
creating a whitespace node in the augmented parse tree; and
associating the whitespace node with a token node in the augmented parse tree.

3. The system of claim 1, further comprising:
in response to determining that a token in the program source code fails to comply with syntactical rules for a programming language of the program source code, creating a skipped token node in the augmented parse tree; and
associating the skipped token node with a token node in the augmented parse tree.

4. The system of claim 1, further comprising:
receiving non-syntactic information comprising comments;
creating a comments node in the augmented parse tree; and
associating the comments node with a token node in the augmented parse tree.

5. The system of claim 1, further comprising:
receiving non-syntactic information comprising line continuation punctuation;
creating a line continuation punctuation node in the augmented parse tree; and
associating the line continuation node with a token node in the augmented parse tree.

6. The system of claim 1, further comprising:
in response to diagnosing a syntax error, attaching syntax error information to a token node in the augmented parse tree.

7. The system of claim 1, further comprising:
receiving non-syntactic information comprising a pre-processor directive;
creating a pre-processor directive node in the augmented parse tree; and
associating the pre-processor directive node with a token node in the augmented parse tree.

8. A method of parsing program source code comprising:
receiving non-syntactic information in program source code;
determining a type of the non-syntactical information;
creating a new node for the non-syntactic information in an augmented parse tree, the new node of the determined type of the non-syntactical information;
receiving a modification to the program source code;
creating a new augmented parse tree representing the modified source code by incrementally parsing the modification without reparsing all of the program source code; and
reconstructing the modified source code comprising non-syntactical information from the new augmented parse tree.

9. The method of claim 8, further comprising:
receiving the non-syntactic information comprising text associated with pre-processing;
creating a text associated with pre-processing node in the augmented parse tree; and
associating the text associated with pre-processing node with a token node in the augmented parse tree.

10. The method of claim 8, further comprising:
receiving non-syntactic information comprising text preceding or following a token;
creating a leading text node in the augmented parse tree for the text preceding the token or creating a trailing text node in the augmented parse tree for the text following the token; and
associating the leading text node with a token node in the augmented parse tree or associating the trailing text node with the token node in the augmented parse tree.

11. The method of claim 8, further comprising:
receiving non-syntactical information comprising structured information;
creating a sub-tree for the structured information in the augmented parse tree; and
associating the sub-tree with a token node in the augmented parse tree.

12. The method of claim 8, further comprising:
receiving a modification to the source code represented by the augmented parse tree, the modification comprising a whitespace portion and an elastic whitespace portion;
creating a second augmented parse tree representing modified source code;
reformatting the elastic whitespace portion of the modification;
not reformatting the whitespace portion of the modification; and
reconstructing the modified source code from the second augmented parse tree.

13. The method of claim 8, further comprising:
in response to determining that an expected token is missing in the program source code, creating a missing token node in the augmented parse tree; and
associating the missing token node with a token node in the augmented parse tree.

14. The method of claim 8, further comprising:
receiving a particular numeric value in a particular textual format; and
storing the particular numeric value, and the textual format used to denote the particular numeric value in the augmented parse tree.

15. A computer-readable storage medium comprising computer-executable instructions which when executed cause at least one processor of a computing device to:
receive syntactic information and non-syntactic information from program source code;
create an augmented parse tree representing all syntactic and non-syntactic information in the program source code by calling application programming interfaces;
reconstruct the program source code exactly, character for character from the augmented parse tree.

16. The computer-readable storage medium of claim 15, comprising further computer-executable instructions, which when executed cause at least one processor to:
store syntax error information detected in the program source code in the augmented parse tree.

17. The computer-readable storage medium of claim 15, comprising further computer-executable instructions, which when executed cause at least one processor to:
determine a type of the non-syntactic information in the program source code; and
create a trivia node of the type of the non-syntactic information; and
associate the trivia node with a token node in the augmented parse tree.

18. The computer-readable storage medium of claim 15, comprising further computer-executable instructions, which when executed cause at least one processor to:
receive a modification to the program source code; and
modify the augmented parse tree without reparsing all of the program source code to generate a new augmented parse tree.

19. The computer-readable storage medium of claim 15, comprising further computer-executable instructions, which when executed cause at least one processor to:
provide the augmented parse tree to a code analysis tool.

20. The computer-readable storage medium of claim 15, comprising further computer-executable instructions, which when executed cause at least one processor to:
store structured non-syntactical information comprising structured comments or structured directives in structured sub-parse trees associated with token nodes in the augmented parse tree.
